(19) United States
(12) Patent Application Publication
(10) Pub. No.: US 2018/0192177 A1
(43) Pub. Date: Jul. 5, 2018

(54) EXTENDED REALITY HEADSETS INCLUDING REMOVABLE EAR CUPS AND RELATED STRUCTURES

(71) Applicant: Muzik, Inc., Raleigh, NC (US)

(72) Inventor: Michael Craig Krisztal, West Hollywood, CA (US)

(21) Appl. No.: 15/863,663

(22) Filed: Jan. 5, 2018

Related U.S. Application Data
(60) Provisional application No. 62/442,448, filed on Jan. 5, 2017.

(51) Int. Cl. H04R 1/10; H04R 1/02; G06F 1/16

(52) U.S. Cl. CPC H04R 1/105; H04R 1/028; H04R 2499/15; G06F 1/1654; G06F 1/163

(57) ABSTRACT

An extended reality headset can include a main housing comprising a unitary soft foam material defining an interior viewing space inside the main housing. A lens assembly can be configured to removeably hold a left lens and a right lens in the interior viewing space. A head strap can be configured to removeably hold the interior viewing space to a user's head. A first audio cup can be configured to moveably couple to a first position on the head strap opposite a right ear of the user and a second audio cup can be configured to moveably couple to a second position on the head strap opposite a left ear of the user.

### CROSS-REFERENCE TO RELATED APPLICATION

This U.S. non-provisional patent application claims priority under 35 U.S.C. § 119 to U.S. Provisional Application No. 62/442,448 entitled Virtual Reality Goggles filed on Jan. 5, 2017, in the U.S.P.T.O., the entire content of which is incorporated herein by reference.

### FIELD

The present inventive concept is related to the field of wearable viewing devices.

### BACKGROUND

Some extended reality headsets, or goggles, may provide a visual display through lenses. The lenses may focus and reshape an image where each lens may display a two-dimensional image that, when viewed simultaneously, a user may perceive a single three dimensional image. The lenses may be curved to create the perception of the three-dimensional (3D) image. The curvature of the lenses may be dependent on the user's pupillary distance.

### SUMMARY

Embodiments according to the inventive concept can provide extended reality headsets including removable ear cups and related structures. Pursuant to these embodiments, an extended reality headset can include a main housing comprising a unitary soft foam material defining an interior viewing space inside the main housing. A lens assembly can be configured to removably hold a left lens and a right lens in the interior viewing space. A head strap can be configured to removably hold the interior viewing space to a user's head. A first audio cup can be configured to moveably couple to a first position on the head strap opposite a right ear of the user and a second audio cup can be configured to moveably couple to a second position on the head strap opposite a left ear of the user.

In some embodiments, an audio ear cup can include an outer portion of the audio ear cup, the outer portion comprising a unitary soft foam material. An attachment point can be on the outer portion, where the attachment point can be configured to removably couple the audio ear cup to a head strap of an extended reality headset and a recess can be in the audio ear cup formed by an interior of the outer portion, wherein the recess is configured to compressably hold a replaceable audio output component therein.

In some embodiments, an extended reality headset can include a main housing of a unitary soft foam material defining an interior viewing space inside the main housing. A unitary soft foam lens frame can be configured to provide a compression fit into the interior viewing space. The unitary soft foam lens frame can include a left lens frame configured to removably hold a left lens in the interior viewing space. A right lens frame can be configured to removably hold a right lens in the interior viewing space and a hinge can be between the left lens frame and the right lens frame, the hinge configured to moveably couple the left lens frame to the right lens frame.

In some embodiments, an extended reality headset can include a main housing of a unitary soft foam material defining an interior viewing space inside the main housing. The main housing can include an insertion slot in a side surface of a forward portion of the main housing, the insertion slot can be configured to provide compressable insertion of an electronic device including a screen configured to display extended reality images, into the interior viewing space and a compression relief slit can be in an upper or lower surface of the forward portion of the main housing aligned to the insertion slot and configured to relieve a compression fit on the electronic device when inserted into the insertion slot.

### BRIEF DESCRIPTION OF THE DRAWINGS

FIG. 1 is a perspective view of an extended reality head set including a main housing coupled to removable audio ear cups by a head strap via respective attachment points in some embodiments according to the inventive concept.

FIG. 2 is an exploded perspective view of the extended reality head set of FIG. 1 further illustrating a lens frame assembly configured for insertion into an interior viewing space of the main housing and respective removable audio output components configured for insertion into the audio ear cups in some embodiments according to the inventive concept.

FIGS. 3A-3D are perspective views of the extended reality head set of FIGS. 1 and 2 further illustrating a cable capture feature integrated into the main housing and further illustrating the interior viewing space of the main housing in some embodiments according to the inventive concept.

FIGS. 4A-4C are perspective views of the main housing of the extended reality head set of FIGS. 1-3 further illustrating openings configured to hold the lens frame assembly in the interior viewing space, to install an electronic device in the main housing via an insertion slot, to relieve compression on the electronic device via a compression relief slit, to stiffen the main housing via ribs, and to expose a camera of the electronic device via openings in a forward facing surface of the main housing independent of orientation of the electronic device in the insertion slot in some embodiments according to the inventive concept.

FIGS. 5A-5C are perspective views of an audio ear cup configured to house the replaceable audio output components in a recess of the audio ear cup and including an outer portion that includes a head strap slot via which the audio ear cup is adjustable to positions on the head strap in some embodiments according to the inventive concept.

FIG. 6 is an exploded perspective view of an over-ear audio ear cup and a respective replaceable audio output component configured to be compressible held in the recess of the over-ear audio ear cup and including a cable slit in the outer portion to allow an audio cable to feed through the outer portion to the replaceable audio output component in some embodiments according to the inventive concept.

FIGS. 7A-7C are perspective views of an on-ear audio ear cup configured to house the replaceable audio output components in a recess of the on-ear audio ear cup and including an outer portion that includes a head strap slot via which the on-ear audio ear cup is adjustable to positions on the head strap in some embodiments according to the inventive concept.

FIGS. 8A-8C are perspective views of a lens frame including left and right lens frames each configured to house respective eye lenses in respective recesses in the left and right lens frames that are moveably coupled together by a hinge therebetween that allows the left and right lens frames to move in unison in some embodiments according to the inventive concept.

FIG. 9 is a perspective view of a head strap connector that is configured to couple to a left and right head strap and a top head strap in some embodiments according to the inventive concept.

FIG. 10 is a perspective view of a input switch that is configured to pass through an opening in the main housing proximate to a touch sensitive screen on the electronic device inserted into the main housing in some embodiments according to the inventive concept.

### DETAILED DESCRIPTION OF EMBODIMENTS ACCORDING TO THE INVENTIVE CONCEPT

Embodiments of the present inventive subject matter now will be described more fully hereinafter with reference to the accompanying drawings, in which embodiments of the present inventive subject matter are shown. This present inventive subject matter may, however, be embodied in many different forms and should not be construed as limited to the embodiments set forth herein. Rather, these embodiments are provided so that this disclosure will be thorough and complete, and will fully convey the scope of the present inventive subject matter to those skilled in the art. Like numbers refer to like elements throughout.

As used herein the term “soft foam material” includes a durable foam material that may provide for easy of manufacturing and for structural integrity to support the use of electronic devices. The foam material may flex to allow for wider range of users and may be light-weight compared to typical solid construction materials, e.g., plastics or metals. The material may allow for a snug fit for a large range of head sizes, providing a one-size-fits-all solution. In addition, the durable foam may also provide for comfort as it is worn by the user by allowing the main housing to adapt to the facial shape of the user and distribute pressure caused by the weight of the system. Further, the density of the material may allow for stability of the overall structure and the various components. That is, the foam material may absorb impacts, torsional and compressive forces.

Also, the use of a foam material may allow for a simplified construction process (manufacture) compared to construction with hard structural frames in addition to a soft material for comfort, e.g., a foam pad interposed between a hard structural frame and the user's face/head. The foam material can be formulated with anti-microbial chemicals, which may provide better hygiene than other materials. The use of closed cell foam or any foam with a (e.g., non-permeable) skin permits easy cleaning and thus provides additional hygienic benefits in comparison to other materials. The use of foam material to construct the main body (and/or other portions of the apparatus) may allow one or more of the components described above to be omitted or replaced, where the foam material itself provides the functionality of the omitted components.

As described herein, in some embodiments according to the inventive concept an extended reality head set can include a main housing that is formed, for example, as a unitary body of relatively soft foam material and can provide numerous features for the head set integrated into the main housing. For example, in some embodiments, the main housing can include an integrated cable capture feature, such as a channel formed in surfaces of the main housing, where an audio cable may be recessed into the channel. Capturing the cable can make for a more convenient arrangement in an extended reality application that uses audio as a feature of the user's experience.

In still further embodiments, removeable audio ear cups can moveably couple to the extended reality head set via respective attachment points on the audio ear cups. The audio ear cups may be moveable to different positions on the head strap that is otherwise used to secure the extended reality head set to the user's head. For example, in some embodiments, the audio ear cups can include a slot as the attachment point, where the head strap is threaded through the slot. The audio ear cup can be moved to align with the user's ear by sliding the head strap through the slot. As described herein, the attachment point can be any structure that allows the audio ear cup to be positioned and secured at a particular point of the head strap. The removeable audio ear cups according to the inventive concept can, therefore, allow a more satisfying extended reality experience by enabling higher quality audio for the user and, particularly when used in conjunction with the other feature described herein, such as the cable capture feature.

Still further, in some embodiments the audio ear cup can be formed of a soft foam material to provide a recess inside the audio ear cup that is configured to house a replaceable audio output component, such as a module with magnets, drivers, etc. used to provide audio output. Further, the audio ear cup can include a slit that is configured to allow a cable to pass through a side wall of the audio ear cup into the recess to the replaceable audio output component housed in the recess. The recess can be configured to provide a compressible fit for the replaceable audio output component such that no hardware is required to secure the replaceable audio output component inside the audio ear cup. In addition, the recess can be standardized to house and compressibly hold a variety of different replaceable audio output components or other components including other features and functions (such as imaging capture and projection). For example, the replaceable audio output component may be replaced with a compatible component that provides higher quality audio output. Still further it will be understood that the replaceable audio output components or other components may be attached to the side head straps and/or the top head strap and may be an over-ear or on-ear configuration.

In still further embodiments, a lens frame assembly can be formed of a unitary soft foam material. This unitary that includes features to allow the lens frame assembly to be inserted into the main housing and compressibly retained in the interior viewing space. Still further, in some embodiments, the lens frame assembly can include a left lens frame and a right lens frame each configured to compressibly retain a respective lens which can be housed in a recess. The left and right lens frames can be coupled together by a hinge (sometimes referred to as a “living hinge”) that allows the left and right lens frames to be positioned in the interior viewing space relative to the user's eyes. Furthermore, the hinge is configured to allow the left and right lens frames to move in unison with one another. In some embodiments, the hinge can be formed by folds in the unitary soft foam material to provide for the movement described herein.

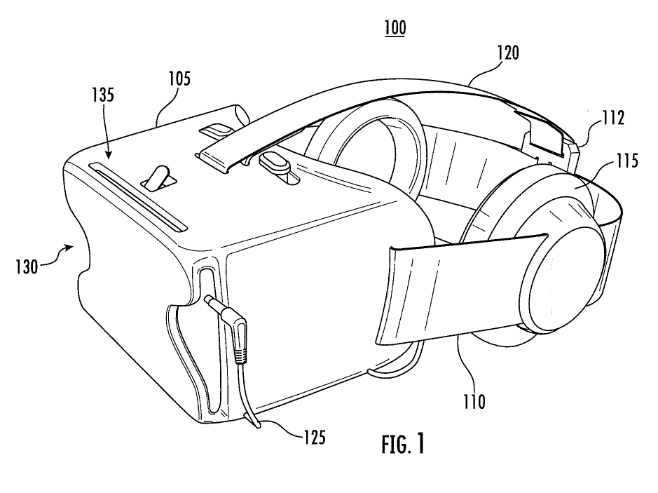

FIG. 1 is a perspective view of an extended reality head set 100 including a main housing 105 coupled to removable audio ear cups 115 by a head strap 110 via respective attachment points 109 in some embodiments according to the inventive concept. According to FIG. 1 the main housing 105 provides a structural basis for many of the functions and features of the extended reality head set 100. The main housing 105 can be formed to provide an interior viewing space 107 that is visible to the user when wearing the extended reality headset 100. For example, the main housing 105 can include an insertion slot 130 in a forward portion of a side surface of the main housing. The insertion slot 130 can allow electronic devices of different sizes to be inserted into the main housing 105 so that images displayed by the electronic device can be visible in the interior viewing space 107 to the user. In particular, the soft foam material used to form the main housing 105 can deform while still maintaining structural integrity to allow variously sized electronic devices to be held in the insertion slot 130.

The main housing can also include a compression relief slit 135 on an upper surface of the main housing 105 adjacent to and aligned with the insertion slot 130. In some embodiments, the compression relief slit 135 is a cut in the soft foam material which can reduce some of the compressive force that may occur when the electronic device in the insertion slot 130 is relatively large. As appreciated by the present inventor, the compression relief slit 135 may ease the insertion/removal of relatively large electronic device into/from the main housing 105 via the insertions slot 130. Furthermore, the compression relief slit 135 may allow for the use of later developed electronic devices (with larger displays) with the extended reality head set 100.

As further shown in FIG. 1, the main housing 105 is coupled to the head strap 100 which is configured to hold the extended reality head set 100 on the user's head during use. A top head strap 120 can also be coupled to the main housing 105 to further secure the extended reality head set 100 on the user when, for example, the electronic device 100 is relatively large/heavy. The head strap 110 and the top head strap 120 are each connected to a head strap connector 112 positioned at a rear of the extended reality head set 100.

Removeable audio ear cups 115 are moveably coupled to the head strap 110 so that the user may move each of the audio ear cups 115 to align with the user's ears. The removeable audio ear cups 115 are attached to particular positions on the head strap by respective attachment points 109. The removeable audio ear cups 115 can be repositioned by, for example, sliding the removeable audio ear cups 115 along the head strap 110. Furthermore, the removeable audio ear cups 115 can be positioned independently of one another and may be removed completely from the head strap 110 so that a new audio ear cup may be installed.

Still referring to FIG. 1, an audio cable 125 is shown proximate to the insertion slot 130 so that audio can be provided from the electronic device in the insertion slot 130 to the left and right removeable audio ear cups 115. The audio cable 125 can be controlled by the cable capture features described herein to provide a more realistic and convenient experience for the user in that the cable capture features may reduce movement of the audio cable 125 so as not distract the user.

an exploded perspective view of the extended reality head set of FIG. 1 further illustrating a lens frame assembly configured for insertion into an interior viewing space of the main housing and respective removable audio output components configured for insertion into the audio ear cups in some embodiments according to the inventive concept.

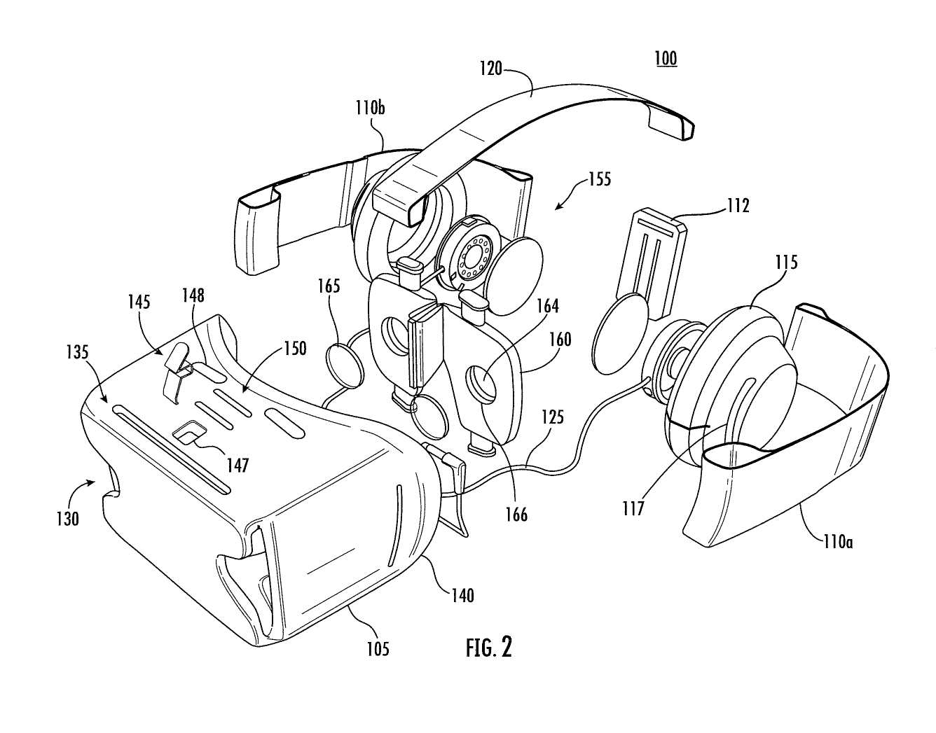

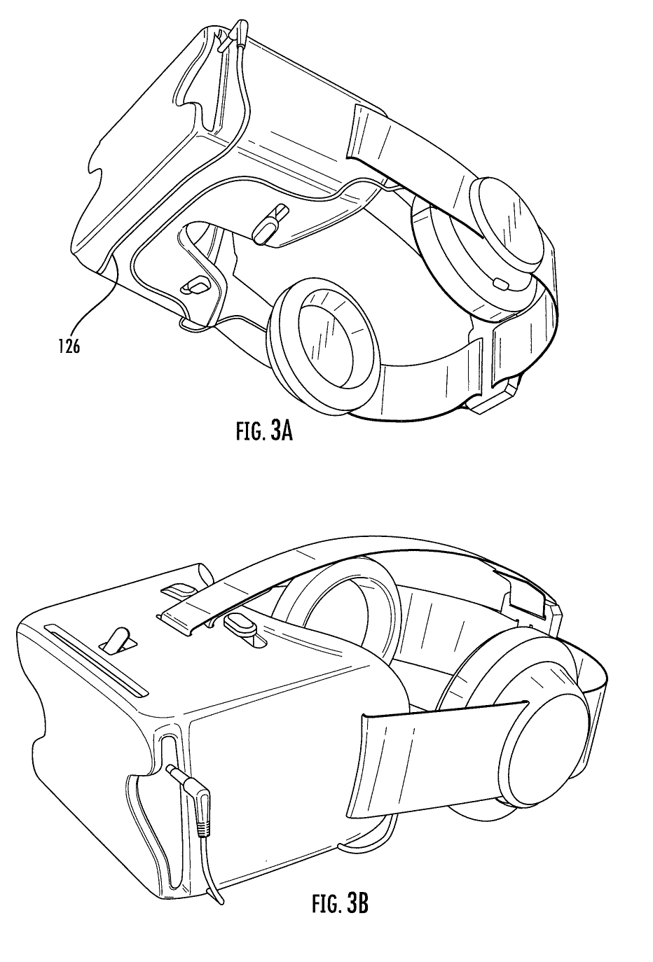

FIGS. 3A-3D are perspective views of the extended reality head set of FIGS. 1 and 2 further illustrating a cable capture feature integrated into the main housing and further illustrating the interior viewing space of the main housing in some embodiments according to the inventive concept.

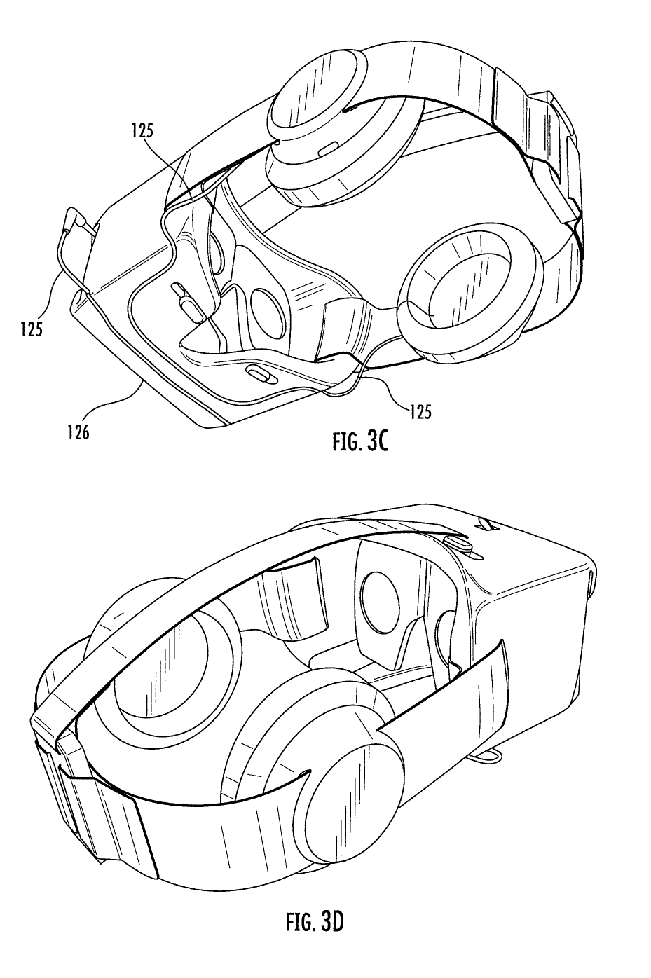

FIGS. 4A-4C are perspective views of the main housing 105 of the extended reality head set 100 of FIGS. 1-3 further illustrating openings configured to hold the lens frame assembly 160 in the interior viewing space 170, to install an electronic device in the main housing 105 via the insertion slot 130, to relieve compression on the electronic device via the compression relief slit 135, to stiffen the main housing via ribs 137, and to expose a camera of the electronic device via openings in a forward facing surface 136 of the main housing 105 independent of orientation of the electronic device in the insertion slot 130 in some embodiments according to the inventive concept.

As shown in FIGS. 4A and C an upper and lower surfaces of the main housing can include openings 148 that are configured to receive upper and lower vertical tabs of the lens frame assembly 160. The lens frame assembly can be a unitary structure that is formed of the soft foam material described herein. The soft foam construction of the lens assembly 160 can allow the lens assembly 160 to be compressed for insertion into the interior viewing space 107 of the main housing 105. Once installed in the interior viewing space 107, the soft foam material can provide a compressive force to on the upper and lower surfaces of the main housing 105 to stabilize the lens assembly 160.

The main housing 105 also includes openings 150 configured to connect the top head strap 120. The opening 147 is configured accept the control switch 145 to make contact with a touch sensitive screen of an electronic device in the insert slot 130. The openings 138 are located on opposite ends of the forward facing surface 136 and are symmetric with one another to allow exposure (prevent occlusion) of a camera electronic device in the insert slot 130 independent of the orientation of the electronic device in the insert slot 130. In other words, the camera lens may not be blocked regardless of how a mobile phone is inserted into the housing and regardless of whether the camera is located near a corner of the mobile phone or nearer the center of the mobile phone. Still further the openings 138 are located and shaped to also allow unrestricted access to an audio output jack of the electronic device.

As further shown in FIGS. 4A-4C, the main housing 105 includes sleeves and/or pockets configured to house ribs 139. The ribs 139 can be added to any of the surfaces of the main housing 105 to increase the rigidity of the main housing 105. For example, the ribs 139 can be added to the forward facing surface 136, the side surfaces 141 and/or the lower surface. Moreover, any combination of ribs 139 may be supported.

The main housing 105 can also include sleeves 142 and/or pockets 143 to secure the ribs 139. For example, the upper surface of the main housing 105 can include the sleeve 147 so that a rib 139 can be inserted into the sleeve 142. In some embodiments, opposing pockets on the surface of the main housing 105 may be used to secure the ribs 139. In particular, the pockets 143 may be spaced apart from one another on the surface of the main housing 105 at a particular distance so that the opposite ends of the ribs 139 can be compressively inserted into respective opposing ones of the pockets 143 to further stiffen the main housing. It will be understood that the sleeves and pockets can be formed integrated into the unitary structure of the main housing 105.

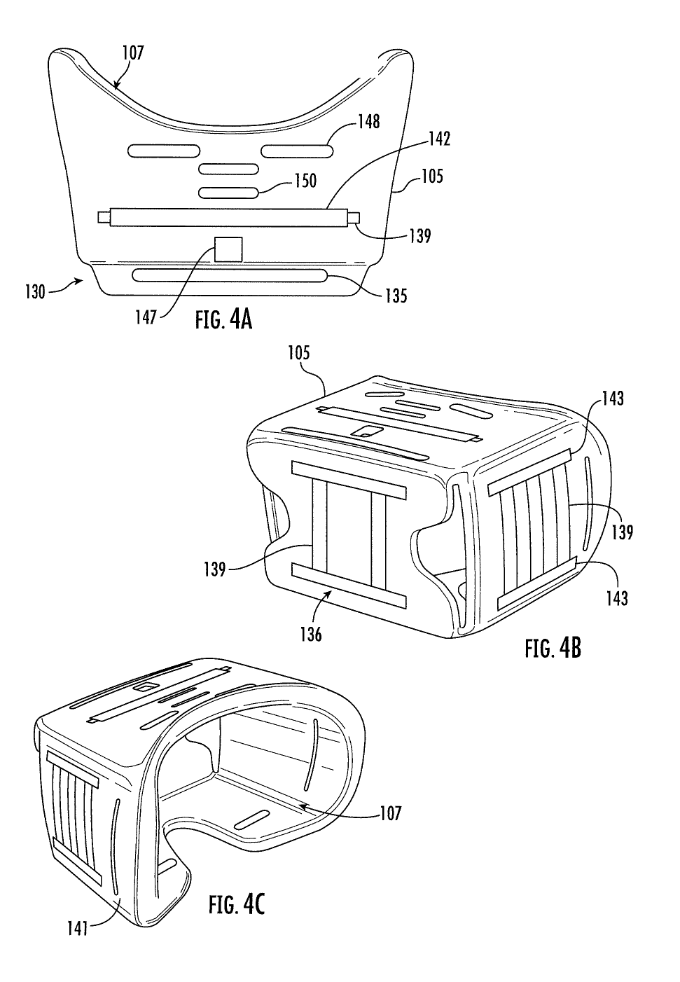

FIGS. 5A-5C are perspective views of an over-ear audio ear cup 115 configured to house a replaceable audio output component in a recess 123 of the audio ear cup and including an outer portion 177 that includes a head strap slot 117 (as an attachment point) via which the audio ear cup 115 is adjustable to different positions on the head strap 110 in some embodiments according to the inventive concept.

According to FIGS. 5A and 5C, the head strap slot 117 is closed from the upper to the lower surface of the outer portion 177 but is open front to back to allow the head strap slot 117 to pass through the slot 117 and retain the audio ear cup 115 in a selected position relative to the user's ear. It will be understood that although the attachment point shown in FIGS. 5A and 5C is in the form of a slot, other attachment points may be utilized. For example, in some embodiments, the slot is open for at least some part of the outer portion 177 to allow the head strap 110 to be inserted through the dotted region 187 rather than passing through the slot from the front to the back. In still other embodiments according to the inventive concept, the attachment point can be provided by a hook and look structure on the outer portion 117 and on the head strap 110 so that no slot is required.

As further shown in FIGS. 5A and 5C, the outer portion 177 of the audio ear cup 115 includes a cable slit 118 that is sized to allow a cable to pass through the slit 118 into the recess 123 inside the audio ear cup 115. It will be understood that the cable slit 118 can be a cut through the soft foam material so that the cable is under compressive force when extending through the slit 118 into the recess. In other embodiments, the slit 118 can have a larger diameter. As further shown a remote end of the cable slit 118 includes a relatively wider opening that allows the cable to be retained in the cable slit 118 during use.

As shown in FIG. 5B the recess 123 is configured to retain the replaceable audio output component therein. In particular, the audio ear cup 115 can be formed of the soft foam material and the recess 123 can have a diameter configured to compressively retain the replaceable audio output component therein. The replaceable audio output component can be seated inside the recess 123 on a ridge 121 having the diameter described above to retain the replaceable audio output component. Still further an audio foam cover can be seated on the ridge 124 to cover the replaceable audio output in the recess 123.

As further shown in FIGS. 5A and 5C, auxiliary electronic components can be provided for in the outer portion 117 of the audio ear cup 115. In particular, the outer portion 117 can include auxiliary openings so that, for example, a video camera 113 and a projector 119 can protrude from the replaceable audio output component through the outer portion 117. It will be understood that other auxiliary electronic components can be accommodated by the replaceable audio output component. Furthermore, in more than two auxiliary electronic components may be provided. Still further, the auxiliary electronic components may face in different directions. For example, a plurality of video cameras may protrude through the audio ear cup 115 and may each face in different directions. Still further, although FIGS. 5A-5C depict the auxiliary electronic components as included with an audio ear cup, the auxiliary electronic components may be associated with other structures. For example, the audio ear cup 115 may be modified to moveably couple to the top head strap 120 and may not provide an audio function, but instead may provide video and projection functions under control of the electronic device.

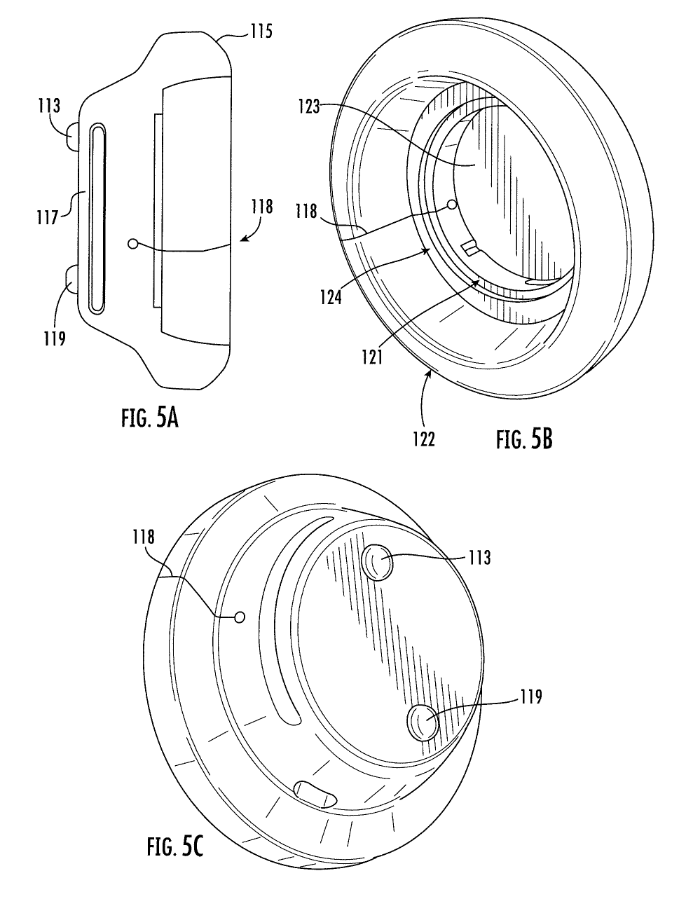

FIG. 6 is an exploded perspective view of an over-ear audio ear cup 115 and a respective replaceable audio output component 116 configured to be compressibly held in the recess 123 of the over-ear audio ear cup 115 and including a cable slit 118 in the outer portion 117 to allow an audio cable 125 to feed through the outer portion 117 to the replaceable audio output component 116 in some embodiments according to the inventive concept. According to FIG. 6, the replaceable audio output component 116 can be selected by the user based on the application. For example, if higher quality audio is desired, a higher fidelity replaceable audio output component can replace the existing replaceable audio output component. In some embodiments, the replaceable audio output component 116 can include a wireless interface, such as WiFi, Bluetooth, or the like.

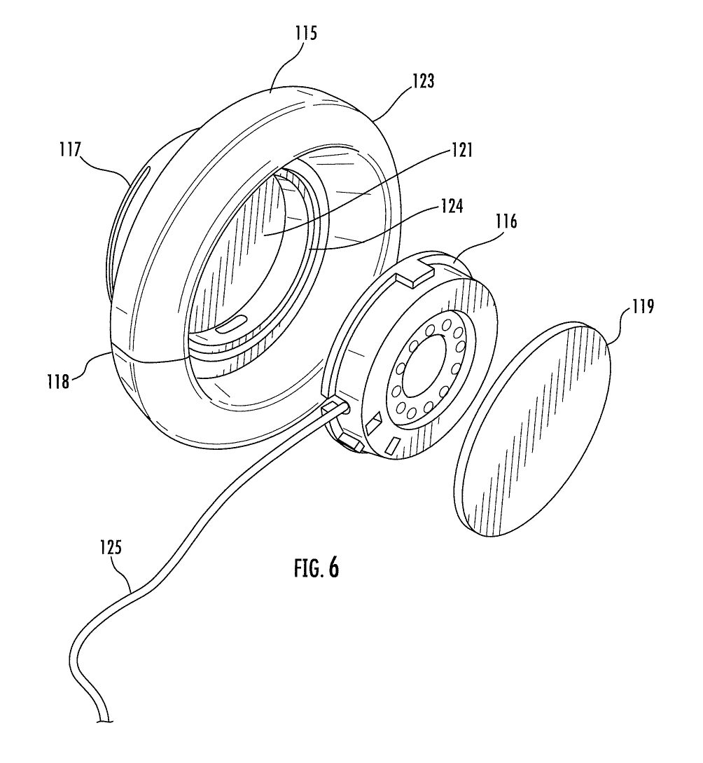

FIGS. 7A-7C are perspective views of an on-ear audio ear cup 175 configured to house the replaceable audio output components 116 in a recess 123 of the on-ear audio ear cup 175 and including an outer portion that includes a head strap slot 117 via which the on-ear audio ear cup 175 is adjustable to positions on the head strap 110 in some embodiments according to the inventive concept. It will be understood that the on-ear audio ear cup 175 does not fully enclose the user's ear. It will be understood that in some embodiments, the components of the on-ear audio ear cup 175 and the over-ear audio ear cup 115 that define the on-ear and over-structure are replaceable and in still further embodiments, the ear cushion component that defines the on-ear and over-function are uniquely identified to the replaceable audio output components, which can be used to select parameters for reproduction of audio to the user, both of which are described in for example, U.S. patent application Ser. No. 15/273,248, filed on Sep. 22, 2016, in the USPTO, the entire disclosure of which is incorporated herein by reference.

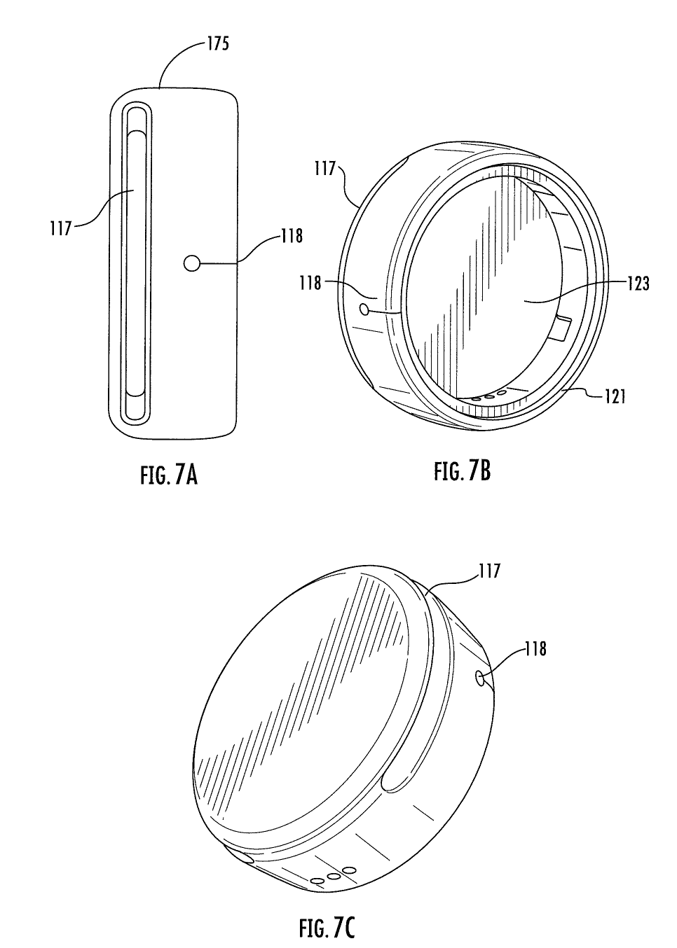

FIGS. 8A-8C are perspective views of a lens frame assembly 160 including left and right lens frames each configured to house respective eye lenses in respective recesses in the left and right lens frames 164 that are moveably coupled together by a hinge 163 therebetween that allows the left and right lens frames 164 to move in unison with one another in some embodiments according to the inventive concept. In particular, FIG. 8B shows the lens assembly is a first position where the left and right lens frames are relatively closely spaced. In contrast, FIG. 8C shows the lens assembly is a second position where the left and right lens frames are relatively widely spaced. The appropriate spacing can be selected by the user base to align the left and right lenses with the left and right eye, respectively.

According to the FIG. 8A-8C, the lens assembly 160 further includes upper and lower vertical tabs 162 for each of the left and right lens frames 164. It will be understood that the lens assembly 160 including the vertical tabs 164 may be formed of the soft foam material to provide the lens assembly as a unitary body. As further shown, the vertical tabs 162 may further include enlarged portions 161 that are configured to protrude through the opening 148 in the main housing 105. The enlarged portions 161 may also form part of the unitary structure of the lens assembly 160, formed from the soft foam material. Still further, the enlarged portions 161 are configured to hold the lens assembly 160 relatively fixed in the interior viewing space 170 during use. In particular, the compressive force applied by the main housing 105 on lens assembly 160 may keep the left and right lens frames (and hence the respective lenses) in the selected positions.

As described herein the hinge 163 is configured to allow the left and right lens frames to move in unison with one another. In some embodiments, the hinge 163 can be formed by folds in the unitary soft foam material to provide for the movement described herein. In some embodiments, the hinge 163 includes at least three folds between the left and right lens frames 164.

In still further embodiments, the main housing 105 may be a foam, rubber, plastic, or other soft material that generally maintains its shape, but is deformable under outside force. The soft main housing can permit a comfortable interface to the face and accommodates the removable components as described herein.

In still further embodiments, the extended reality head set may include a configurable lens assembly. The lens assembly includes a frame that support the lenses. The lenses may be removable or may be permanently attached to the frames. The frames may include two generally planar portions, where each of the planar portions include a rimmed hole to support a lens. The lens frame may comprise a monolithic, integral component. The lens frame may be of a single solid component or may be of two or more pieces permanently attached.

The main housing can have a plurality of apertures to support the lens assembly. For example, the main housing may include two apertures on opposing sides (a top and bottom) of the housing. As shown, the lens assembly may include a plurality of projections configured to insert into the respective apertures of the housing. For example, each planar portion of the lens assembly may include two projections, one opposing sides (top and bottom) of the lens portion.

In an exemplary embodiment, the lens frame may be of a more rigid material than the housing. Therefore, as the lens assembly projections are inserted into the main housing, the main housing may deform around the lens assembly to engage or retain the lens assembly. The housing may frictionally engage the lens assembly, such that a desired position may be retained once the lens assembly is positioned in a desired location within the housing apertures. In an exemplary embodiment, a width of the main housing aperture is longer than a width of the lens assembly projections such that the projection may slide within the aperture, and the planar lens portion may traverse across the housing. In an exemplary embodiment, the lens assembly may move relative to the housing, while the projections are fully seated through the housing aperture.

In an exemplary embodiment, the lens assembly projections include a bulb or enlarged terminal end. The enlarged terminal end defines a flange that retains the lens assembly in the housing. The enlarged end may be tapered in one direction to ease insertion of the lens assembly through the housing aperture. For example, the projection terminal end may be generally flat or tapered. The projection terminal end may enlarge as the projection is traversed toward the lens assembly frame. A step wise discontinuity may then be positioned on a side of the enlarged terminal end such that a ledge or flange is defined between the projection shaft and the enlarged end. The flange is configured to abut the housing and retain the lens assembly within the housing once the lens assembly is fully seated within the housing and the projections are positioned through the housing apertures. The projections have a shaft of generally constant cross section from the lens frame to the enlarged end. The projection cross section is shaped such that the projections are configured to abut and frictionally engage the housing aperture on opposing faces (width-wise faces) and not contact the housing aperture on the remaining opposing faces (depth-wise faces). The length of the projections is such that the housing is configured to be fully positioned along the shaft between the lens frame and the flange defined by the enlarged end of the projection.

In an exemplary embodiment, the lens assembly comprises at least four planar portions coupled by at least three hinges, where a hinge is positioned between adjacent planar portions, and where the terminal planar portions support a lens, respectively. In an exemplary embodiment, the lens assembly comprises at least five planar portions coupled by at least four hinges, where a hinge is positioned between adjacent planar portions, and where the terminal planar portions support a lens, respectively.

In an exemplary embodiment, the lens assembly is adjustable such that the lens may be positioned to match a pupillary distance for a specific user, while maintaining a standard manufacturing google. As shown, the adjustable lens may comprises a hinged portion between the two planar portions supporting the lenses. The hinged portion may connect the two planar portions together but permit the planar portions to move laterally relative to each other. In an exemplary embodiment, the hinged portion may comprise a plurality of hinges. For example, a hinge may be positioned between each of the respective planar portions supporting the lenses and a connecting planar portion. Another hinge may couple the respective connecting planar portion. Therefore, as the lens assembly is traversed from one side to the other, the lens assembly may comprise: a first planar portion supporting a first lens, a first hinge, a first planar connecting portion, a connecting hinge, a second planar connecting portion, a second hinge, and a second planar portion supporting a second lens. The connecting hinge may also include one or two hinges and another connecting portion. For example, the connecting hinge may include an additional first and second hinge attached to the first and second planar connecting portions respectively, and the additional first and second hinge are coupled through a thing connecting portion.

In an exemplary embodiment, the hinges comprise living hinges. For example, the lens assembly including the planar portions and the hinge may be a single, monolithic piece, integrally formed. The hinge may be created by a reduced thickness area to permit bending of the component at the hinge. Other hinge configurations may also be used.

In an exemplary embodiment, a lens assembly may comprise a first planar portion supporting a first lens and having two projections extending from opposing sides (top and bottom); a first hinge coupled to the first planar portion; a first connecting planar portion coupled to the first hinge and a connecting hinge on opposing sides; a second connecting planar portion coupled to the connecting hinge and a second hinge on opposing sides; and a second planar portion supporting a second lens and having two projections extending from opposing sides. Each of the projections including an enlarged terminal end. Each of the enlarged terminal ends defining a flange configured to abut the main housing when the lens assembly is positioned within the housing. Wherein the projections are dimensioned to fit within the main housing apertures respectively and frictionally engage the housing. A first dimension of the projection being less than a corresponding first dimension in the housing such that the projection may move relative to the housing in a direction along the first dimension. A second dimension orthogonal to the first dimension of the projection being approximately equal to or greater than a corresponding second dimension of the housing aperture such that the housing contacts the projection when the lens assembly is fully positioned within the main housing. In an exemplary embodiment, the lens assembly is more rigid than the main housing, such that the main housing deforms when the lens assembly is being positioned within the housing.

In an exemplary embodiment, the lens assembly is configured to be positioned in an open position and a closed position within the housing by sliding the projections along the aperture. The closed position may be where the pupillary distance is a minimum, such as when the first and second planar connecting portions are in contact or substantially parallel to one another. The open position may be where the permitted pupillary distance is a maximum, such as when the first and second planar connecting portions are angled with respect to one another, such as at an acute, right, or obtuse angle. In an exemplary embodiment, the lens may be removable and replaceable within the lens frame.

The term planar used herein is not intended to require an absolutely flat component. Instead, planar is intended to indicate a component in which a plane may be positioned within and/or at a surface of a substantial portion of the component. This is intended to include components that may have slight curvatures to conform to a user's face. As shown, the planar portions are generally linear along at least one dimension. The planar portions may be tapered, such that the thickness of the component is not uniform across the component. The hinge is intended to include any structure that permits the component parts (such as the planar portions) to move and/or rotate relative to one another.

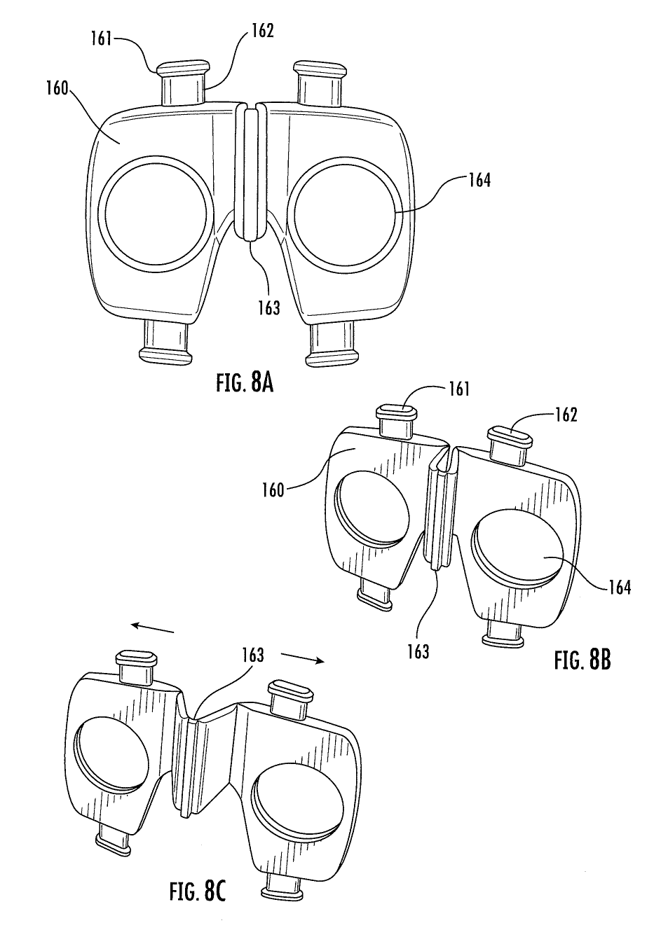

FIG. 9 is a perspective view of a head strap connector that is configured to couple to a left and right head strap and a top head strap in some embodiments according to the inventive concept.

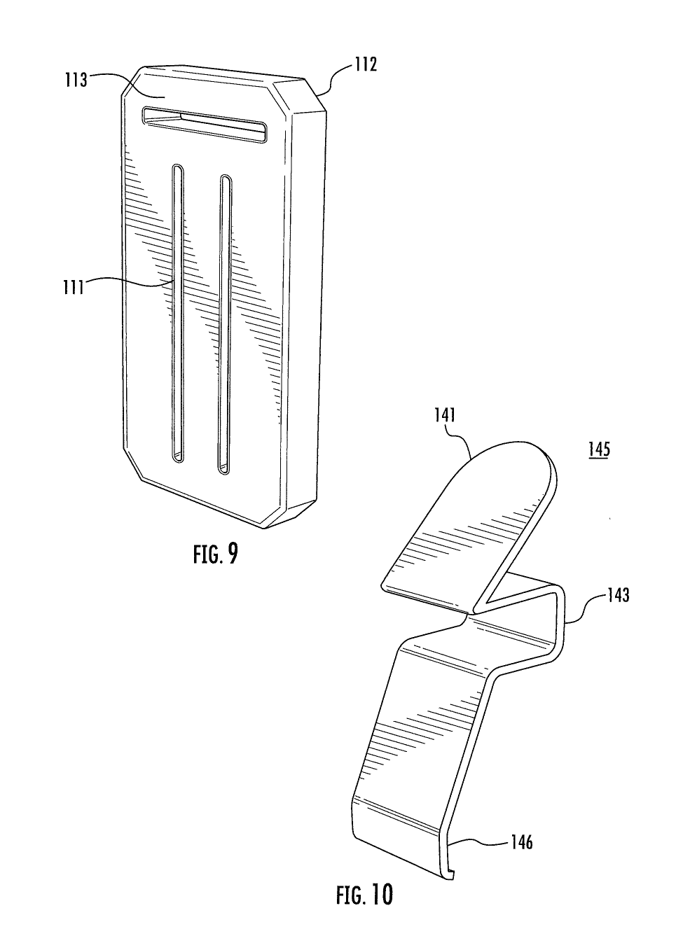

FIG. 10 is a perspective view of an input switch that is configured to pass through an opening in the main housing proximate to a touch sensitive screen on the electronic device inserted into the main housing in some embodiments according to the inventive concept

1.-16. (canceled)

17. An extended reality headset comprising:
a main housing comprising a unitary soft foam material defining an interior viewing space inside the main housing;
a lens assembly configured to removably hold a left lens and a right lens in the interior viewing space;
a head strap configured to removably hold the interior viewing space to a user's head; and
a first audio cup configured to moveably couple to a first position on the head strap opposite a right ear of the user; and
a second audio cup configured to moveably couple to a second position on the head strap opposite a left ear of the user.

18. The headset of claim 17 wherein the first audio cup comprises an outer portion including an attachment point configured to removably couple to the head strap at the first position.

19. The headset of claim 18 wherein the attachment point comprises a head strap slot extending from a front opening on the outer portion of the first audio cup to a rear opening on the outer portion of the first audio cup so that the outer portion fully encloses the head strap slot.

20. The headset of claim 18 wherein the attachment point comprises a head strap slot extending from a front opening on the outer portion of the first audio cup to a rear opening on the outer portion of the first audio cup wherein the outer portion is closed at a lower portion of the slot or an upper portion the head strap slot.

21. The headset of claim 18 wherein the attachment point comprises a head strap slot extending from a front opening on the outer portion of the first audio cup to a rear opening on the outer portion of the first audio cup wherein the outer portion is open at a central portion the head strap slot and the head strap slot is closed at a lower portion of the head strap slot or at an upper portion the head strap slot.

22. The headset of claim 18 wherein the first audio cup includes a recess opposite the outer portion configured to compressably hold a replaceable first audio output component therein.

23. The headset of claim 22 wherein the first audio cup includes a cable slit in the outer portion and elongated from proximate to the attachment point toward an opening of the recess, the cable slit configured to compressably hold a cable coupled to the replaceable first audio output component passing through the cable slit into recess.

24. The headset of claim 23 wherein the cable slit further includes a cable seat that is enlarged relative to a width of the cable slit.

25.-27. (canceled)

28. An audio ear cup comprising:
an outer portion of the audio ear cup, the outer portion comprising a unitary soft foam material;
an attachment point on the outer portion, the attachment point configured to removably couple the audio ear cup to a head strap of an extended reality headset; and
a recess in the audio ear cup formed by an interior of the outer portion, wherein the recess is configured to compressably hold a replaceable audio output component therein.

29. The audio ear cup of claim 28 wherein the attachment point comprises a head strap slot extending from a front opening on the outer portion of the audio cup to a rear opening on the outer portion of the audio cup so that the outer portion fully encloses the head strap slot.

30. The audio ear cup of claim 28 wherein the attachment point comprises a head strap slot extending from a front opening on the outer portion of the first audio cup to a rear opening on the outer portion of the first audio cup wherein the outer portion is closed at a lower portion of the head strap slot or an upper portion the head strap slot.

31. The audio ear cup of claim 28 wherein the attachment point comprises a head strap slot extending from a front opening on the outer portion of the first audio cup to a rear opening on the outer portion of the first audio cup wherein the outer portion is open at a central portion the head strap slot and the head strap slot is closed at a lower portion of the head strap slot or at an upper portion the head strap slot.

32. The audio ear cup of claim 28 wherein the outer portion includes a cable slit elongated from proximate to the attachment point toward an opening of the recess, the cable slit configured to compressably hold a cable coupled to the replaceable audio output component passing through the cable slit into recess.

33. The audio ear cup of claim 32 wherein the cable slit further includes a cable seat that is enlarged relative to a width of the cable slit.

34. The audio ear cup of claim 28 further comprising an audio output foam cover configured to insert into the recess to cover the replaceable first audio output component, wherein the audio output foam cover comprises a unitary soft foam material that is softer than foam comprising the outer portion of the first audio cup.

35. The audio ear cup of claim 28 wherein the outer portion is configured to fully enclose an ear.

36.-39. (canceled)

40. An extended reality headset comprising:
a main housing comprising a unitary soft foam material defining an interior viewing space inside the main housing, the main housing including:
an insertion slot in a side surface of a forward portion of the main housing, the insertion slot configured to provide compressable insertion of an electronic device including a screen configured to display extended reality images, into the interior viewing space; and
a compression relief slit in an upper or lower surface of the forward portion of the main housing aligned to the insertion slot and configured to relieve a compression fit on the electronic device when inserted into the insertion slot.

41. The extended reality headset of claim 40 wherein the main housing further comprises:
a forward facing surface adjacent to the insertion slot and the compression relief slit, the forward facing surface including a left opening in a left side of the forward facing surface and a right opening in a right side of the forward facing surface.

42. The extended reality headset of claim 41 wherein the left opening and the right opening are symmetrical with one another and are configured to expose a camera lens in the electronic device independent of an orientation of the electronic device when in the insertion slot.

43. The extended reality headset of claim 41 wherein the left opening and the right opening are symmetrical with one another and are configured to expose an audio output connector independent of an orientation of the electronic device when in the insertion slot.

44.-46. (canceled)
